(19) United States
(12) Patent Application Publication
(10) Pub. No.: US 2012/0017143 A1
(43) Pub. Date: Jan. 19, 2012

(54) ELECTRONIC DEVICE AND METHOD FOR DATA MANAGEMENT

(75) Inventors: HUI LI, Shenzhen City (CN); FENG-JUAN GAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/869,765

(22) Filed: Aug. 27, 2010

(30) Foreign Application Priority Data
Jul. 15, 2010 (CN) 201010226693.8

(51) Int. Cl. G06F 17/00

(52) U.S. Cl. 715/217

(57) ABSTRACT

An electronic device receives a number of HTML files in a queue. The electronic device reads the HTML files in a spreadsheet format, whereby sets of test data in the HTML files are read as cells of a spreadsheet in EXCEL. Values and names are extracted from the sets of test data by the electronic device. The electronic device compiles the extracted values and names and generates a test report file from the complied values and names.

### BACKGROUND

1. Technical Field

Embodiments of the present disclosure relate to information processing, and more particularly to an electronic device and method for data management.

2. Description of Related Art

Hardware verification in system management and research involves a variety of signals, such as protocol control information express (PCIe) and serial advanced technology attachment (SATA) signals, both of which are often sampled by oscilloscopes and analyzed by specialized test application, such as SIGTEST. However, data from the SIGTEST output files must often be manually transcribed from its native hypertext markup language (HTML) format, to a test report table. Such transcription is not only time-consuming but also prone to error.

### BRIEF DESCRIPTION OF THE DRAWINGS

FIG. 1 is a block diagram of one embodiment of an electronic device.

FIG. 2 is a flowchart illustrating one embodiment of a method for data management.

FIG. 3 shows an exemplary test report generated by the electronic device

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of application instructions, written in a programming language, such as, for example, Java, C, or Assembly. One or more application instructions in the module may be integrated in firmware, such as an EPROM. It will be appreciated that module may comprise connected logic units, such as gates and flip-flops, and may comprise programmable units, such as programmable gate arrays or processors. The units described herein may be implemented as application and/or hardware unit and may be stored in any type of computer-readable medium or other computer storage device.

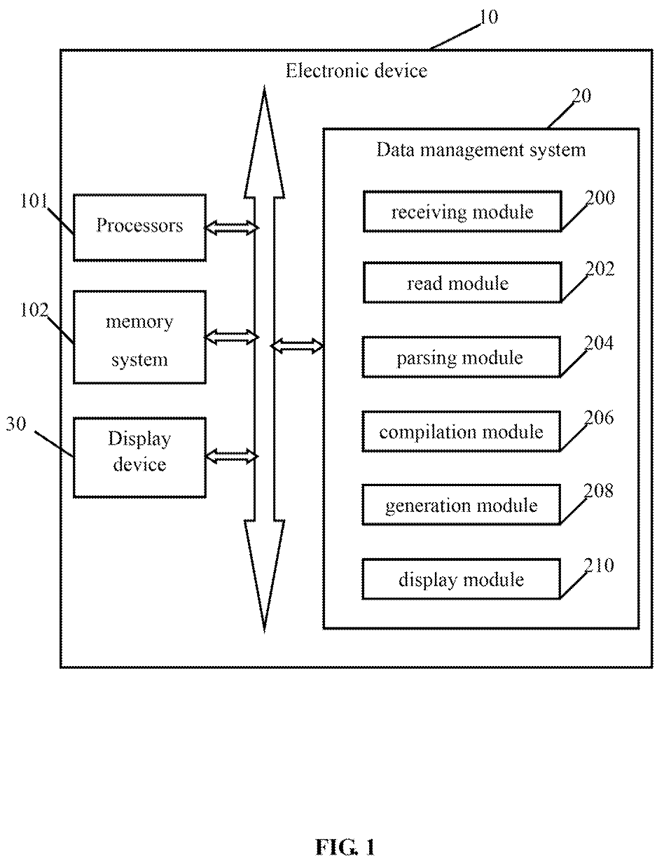

FIG. 1 is a block diagram of one embodiment of an electronic device 10. The electronic device 10 comprises a data management system 20 to reformat a HTML file to a spreadsheet file. In the embodiment, the spreadsheet file can be an EXCEL spreadsheet, or other suitable spreadsheet formats. The data management system 20 comprises programs including a receiving module 200, a read module 202, a parsing module 204, a compilation module 206, a generation module 208, and a display module 210. One or more computerized codes of the modules 200-210 are stored in a memory system 102 and executed by one or more processors 101 of the electronic device 10. The electronic device 10 further electronically communicates with a display device 30.

In the embodiment, the receiving module 200 receives test result files showing output of electronic signals from a test subject using a specialized test application, such as SIGTEST. The test subject can be a PCIe or SATA, for example. In the embodiment, the output files are exported as HTML files. Each HTML file contains one or more sets of test data, such as test numbers, test dates, and file names. For example, a set of test data can include “No.:187, Date:2010/3/9, FILE NAME: sata1_{—}1.5g, Mean Unit Interval:666.674574, Max Unit Interval:666.853047, Min Unit Interval:666.425864”. The receiving module 200 maintains the received HTML files in a queue data structure stored in the memory system 102.

In the embodiment, the read module 202 reads the HTML files in EXCEL format, such that each column of a set of test data corresponds to a cell of a spreadsheet. For example, “No.:187” corresponds to the first column of the first row in the spreadsheet, “Date:2010/3/9” corresponds to the second column of the first row, and so on.

In the embodiment, the parsing module 204 extracts values and names from the one or more sets of test data. Each dataset has a name and value, separated by a colon. For example, the dataset “No.:187” has the name “No.” and the value “187”.

In the embodiment, the compilation module 206 imports the extracted names and values to a database (e.g., an ACCESS database) for layout and exportation (hereinafter the “compilation”). The generation module 208 exports the compiled names and values from the ACCESS database and generates a test report in EXCEL format. The generation module 208 generates the test report when the last HTML file is pushed out of the queue. The display module 210 displays the test report on the display device 30.

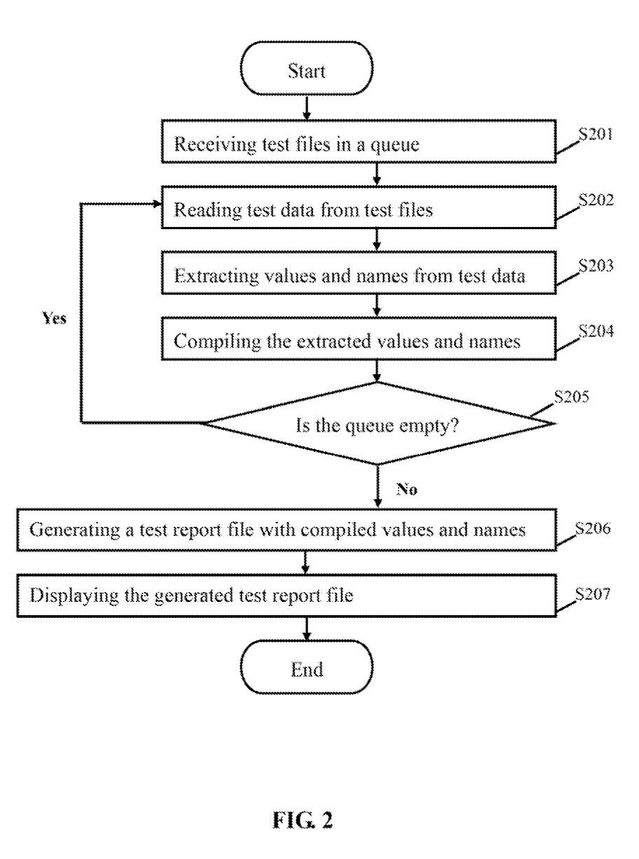

FIG. 2 is a flowchart illustrating one embodiment of a method for data management. Additional blocks may be added to the method, others removed, and the ordering of the blocks may be changed.

In block S201, the receiving module 200 receives HTML files containing one or more sets of test data, in the queue. In block S202, the read module 202 reads the HTML files in EXCEL format, such that each column of a set of test data corresponds to a cell in the spreadsheet in EXCEL. In block S203, the parsing module 204 extracts values and names from the one or more sets of test data. In block S204, the compilation module 206 imports the extracted names and values to an ACCESS database for compilation.

In block S205, the receiving module 200 determines if the queue is empty. If the queue is empty, block S202 is implemented. If the queue is not empty, block S206 is implemented. In block S206, the generation module 208 exports the compiled names and values from the ACCESS database and generates the test report in EXCEL format. In block S207, the display module 210 displays the test report on the display device 30.

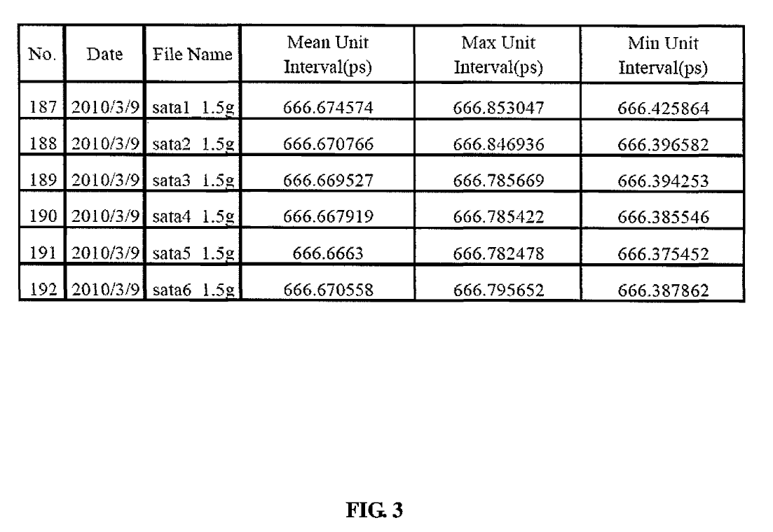

FIG. 3 shows an exemplary test report generated with six sets of test data, wherein the first row shows the extracted names and the following rows show the extracted values. For example, the first cell of the second column is the name “Date”. The second cell of the second column is the value “2010/3/9” extracted from one dataset while the third cell of the second column is the value “2010/3/9” extracted from another.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a memory system;
one or more processors; and
one or more programs stored in the memory system configured to be executed by the one or more processors, the one or more programs comprising:
a receiving module to queue a plurality of HTML files;
a read module to read the plurality of HTML files in a spreadsheet format, such that each column of a set of test data in the plurality of HTML files corresponds to a cell in a spreadsheet;
a parsing module to extract values and names from a plurality of sets of test data read from the plurality of HTML files;
a compilation module to compile the extracted values and names; and
a generation module to generate a test report file with the compiled values and names.

2. The electronic device as claimed in claim 1, further comprising a display module to display the generated test report file on a display device.

3. The electronic device as claimed in claim 1, wherein the compilation module imports the extracted values and names in a database for compilation.

4. The electronic device as claimed in claim 1, wherein the generated test report file is exported as an EXCEL file.

5. The electronic device as claimed in claim 1, wherein the spreadsheet is an EXCEL spreadsheet.

6. A computerized method executed on an electronic device, comprising:
receiving a plurality of HTML files in a queue;
reading the plurality of HTML files in a spreadsheet format, such that each column of a set of test data in the plurality of HTML files corresponds to a cell in a spreadsheet;
extracting values and names from a plurality of sets of test data read from the plurality of HTML files;
compiling the extracted values and names; and
generating a test report file with the compiled values and names.

7. The computerized method as claimed in claim 6 further comprising displaying the generated test report file on a display device.

8. The computerized method as claimed in claim 6, wherein compilation further comprises importing the extracted values and names in a database.

9. The computerized method as claimed in claim 6, wherein the generated test report file is exported as an EXCEL file.

10. The computerized method as claimed in claim 6, wherein the spreadsheet is an EXCEL spreadsheet.

11. A computer readable storage medium having stored therein instructions, that when executed by one or more processors of an electronic device, cause the device to:
receive a plurality of HTML files in a queue;
read the plurality of HTML files in a spreadsheet format, such that each column of a set of test data in the plurality of HTML files corresponds to a cell in a spreadsheet;
extract values and names from a plurality of sets of test data read from the plurality of HTML files;
compile the extracted values and names; and
generate a test report file with the compiled values and names.

12. The computer readable storage medium as claimed in the claim 11, in which the device displays the generated test report file on a display device.

13. The computer readable storage medium as claimed in the claim 11, wherein compilation further comprises importing the extracted values and names in a database.

14. The computer readable storage medium as claimed in the claim 11, wherein the generated test report file is exported as an EXCEL file.

15. The computer readable storage medium as claimed in the claim 11, wherein the spreadsheet is an EXCEL spreadsheet.
